(19) United States
(12) Patent Application Publication
(10) Pub. No.: US 2005/0186480 A1
(43) Pub. Date: Aug. 25, 2005

(54) Gel electrolyte, electrode for fuel cell, fuel cell, and method of producing the gel electrolyte

(76) Inventor: Yuichi Aihara, Yokohama (JP)

Correspondence Address: MCGUIREWOODS, LLP, 1750 TYSONS BLVD, SUITE 1800, MCLEAN, VA, 22102, US

(21) Appl. No.: 11/038,033

(22) Filed: Jan. 21, 2005

(30) Foreign Application Priority Data
Jan. 23, 2004 (JP) 2004-15768
Sep. 14, 2004 (KR) 10-2004-0073361

(51) Int. Cl. H01M 8/10; H01M 4/86; H01M 10/40

(52) U.S. Cl. 429/303; 429/42; 429/33

(57) ABSTRACT

A gel electrolyte having high proton conductivity and improved mechanical strength even at no humidity and high temperatures may include an acid, a linear polymer capable of being swollen by the acid, and a crosslinkable polymer made into a composite with the linear polymer.

### BACKGROUND OF THE INVENTION

This application claims the benefit of Japanese Patent Application No. 2004-15768, filed on Jan. 23, 2004, and the benefit of Korean Patent Application No. 2004-73361, filed on Sep. 14, 2004, both of which are incorporated herein in their entireties by reference.

1. Field of the Invention

The present invention relates to a gel electrolyte, an electrode for a fuel cell, a fuel cell, and a method of producing the gel electrolyte. In particularly, the present invention relates to a gel electrolyte having improved mechanical strength.

2. Description of the Related Art

In fuel cells, an electrolyte membrane may be required to have high proton conductivity for a long period at operating temperatures in the range of about 100 to about is 300° C. and at zero humidity or at a relative humidity of less than about 50%. This requirement has been considered in the development of conventional solid polymer electrolyte fuel cells. However, in a perfluorosulfonic acid membrane, sufficient proton conductivity and output power cannot conventionally be obtained at operating temperatures in the range of about 100 to about 300° C. and a relative humidity of 50% or less.

Japanese Patent Publication No. Hei 11-503262 discloses a solid electrolyte membrane composed of polybenzimidazole impregnated with a strong acid like phosphoric acid. With this type of solid electrolyte membrane, a fuel cell can have improved resistance to oxidation and heat and can be operable at 200° C. or less.

However, the solid electrolyte membrane composed of polybenzimidazole doped with phosphoric acid contains phosphoric acid in 4-5 times by weight more than polybenzimidazole in order to obtain sufficient proton conductivity to operate a fuel cell. Such a membrane with a high concentration of phosphoric acid has lower mechanical strength and can lead to crossover of gas during installation in a fuel cell.

### SUMMARY OF THE INVENTION

The present invention provides a gel electrolyte having high proton conductivity even at no humidification and high temperatures and increased mechanical strength, an electrode for a fuel cell using the gel electrolyte, a fuel cell, and a method of producing the gel electrolyte.

The present invention provides, among other things, a gel electrolyte including an acid, a linear polymer capable of being swollen by the acid, and a crosslinkable polymer made into a composite with the linear polymer.

An example of the acid includes phosphoric acid. The phosphoric acid can include both orthophosphoric acid and condensed phosphoric acid.

The linear polymer and the crosslinkable polymer may be made into a composite, and thus the crosslinkable polymer may not swell even when the linear polymer swells in the acid and the mechanical strength of the gel electrolyte can be protected from weakening.

In the gel electrolyte according to the present invention, the crosslinkable polymer may be crosslinked by irradiation with an electron beam.

The crosslinkable polymer may be crosslinked by irradiation of an electron beam, and this may obviate the need for the use of a polymerization initiator and a crosslinking agent. The polymerization initiator and the crosslinking agents may be impurities in the final product, and thus can lower proton conductivity. Accordingly such a reduction in proton conductivity can be avoided.

In the gel electrolyte, the linear polymer may be polybenzimidazole or a derivative thereof. The linear polymer can be impregnated with a large amount of an acid such as phosphoric acid and the proton conductivity can be increased. In the gel electrolyte, the crosslinkable polymer may be a fluorine-based polymer. Endurance of the gel electrolyte can thus be improved due to the thermal and chemical stability of the fluorine-based polymer. The mechanical strength of the gel electrolyte can also be improved.

In the gel electrolyte, a proportion of the fluorine-based polymer to the sum of the linear polymer and the fluorine-based polymer may be between about 10 to about 40% by mass. Thus mechanical strength and the proton conductivity can simultaneously be improved.

The present invention also provides an electrode for a fuel cell including an electrode material and at least one of gel electrolytes described above. Thus, since the gel electrolyte with high proton conductivity may be included as a part of the electrode, protons can be easily transported to the inside of the electrode and the internal resistance of the electrode itself can be decreased. Due to the increased mechanical strength of the composite gel electrolyte, endurance of the electrode can be improved.

The present invention also provides a fuel cell including a pair of electrodes and an electrolyte interposed between the electrodes. A part (up to the whole) of the electrolyte may be the gel electrolyte described above and the gel electrolyte may be contained in a part of the electrodes. Thus, since the fuel cell includes a gel electrolyte with high proton conductivity and the gel electrolyte is included in a part of the electrode, the internal impedance of the fuel cell can be decreased and the current density can be increased. Further, since the gel electrolyte has very high mechanical strength, endurance of the fuel cell can be improved.

The present invention also provides a method of producing the gel electrolyte. The method can include forming a sheet from a mixture of a linear polymer and a crosslinkable polymer that is not crosslinked, crosslinking the crosslinkable polymer by irradiating an electron beam into the sheet so as to transmit the electron beam from a surface of the sheet to the other surface of the sheet, and impregnating the sheet with an acid. Thus, since the electron beam may be transmitted to the sheet that includes linear polymer and crosslinkable polymer, the crosslinking can occur inside the sheet as well as at the surface of the sheet. Accordingly, a gel electrolyte having a composite of linear polymer and the crosslinked can be obtained in a sheet.

In the method, an accelerated voltage of the electron beam may be about 1 MeV or greater. Thus, crosslinking can occur inside the sheet as well as at the surface of the sheet.

In the method, the linear polymer may be polybenzimidazole or a derivative thereof. Moreover, the crosslinkable polymer may be a fluorine-based polymer. The proportion of the fluorine-based polymer to the sum of the linear polymer and the fluorine-based polymer may be between about 10 to about 40% by mass.

### BRIEF DESCRIPTION OF THE DRAWING

FIG. 1 is a graph illustrating TMA curves of Examples 1, 2, 3, and 4 and Comparative Examples 1 and 3.

### DETAILED DESCRIPTION OF THE INVENTION

A fuel cell according to the present invention can include a hydrogen electrode, an oxygen electrode, and a gel electrolyte interposed between the hydrogen electrode and the oxygen electrode and can be capable of operation at about 100 to about 300° C. A gel electrolyte according to the present invention may have proton conductivity and may transport protons (hydrogen ions) generated in the hydrogen electrode to the oxygen electrode. The protons transported by the gel electrolyte may electrochemically react with oxygen ions in the oxygen electrode to produce water and simultaneously generate energy.

In a fuel cell according to the present invention, the hydrogen electrode and the oxygen electrode may also include the gel electrolyte. In other words, an electrode material, such as activated carbon, and a binder for solidifying and shaping the electrode material may be contained in the hydrogen electrode and the oxygen electrode and a part up to the whole of the binder may be composed of a gel electrolyte according to the present invention. Thus, protons may easily be transported between the inside and the outside of the electrode and the internal resistance of the electrode may decrease.

The gel electrolyte according to the present invention may include an acid, a linear polymer capable of being swollen by the acid, and a crosslinkable polymer made into a composite with the linear polymer. An example of the acid is phosphoric acid. Phosphoric acid can be both orthophosphoric acid and condensed phosphoric acid. The linear polymer can be any polybenzimidazole or derivative thereof. The crosslinkable polymer can be a fluorine-based polymer. The term “made into a composite” means that the linear polymer is mixed with the crosslinkable polymer such that the linear polymer is inserted within the crosslinking structure of the crosslinkable polymer.

Polybenzimidazole or a derivative thereof as the linear polymer can be appropriately used for an electrolyte of a fuel cell in view of its excellent thermal resistance and capability of including a large amount of phosphoric acid. However, its mechanical strength decreases as the concentration of phosphoric acid increases. In the present invention, since polybenzimidazole or a derivative thereof may be made into a composite with the crosslinkable polymer (fluorine-based polymer) which is two- or three-dimensionally crosslinked, a lowering of the mechanical strength of the gel electrolyte itself can be prevented. Further, even when polybenzimidazole or a derivative thereof is made into a composite with the fluorine-based polymer, its molecular structure rarely changes. Thus the concentration of phosphoric acid may not be reduced.

The polybenzimidazole for forming the gel electrolyte is a linear polymer having formula (1) below. In formula (1) below, n₁ is about 10 to about 100,000. If n₁ is less than about 10, the mechanical strength may be lowered. If n₁ is greater than about 100,000, the solubility in a solvent may be significantly reduced and it may be difficult to form the gel electrolyte into a desired shape.

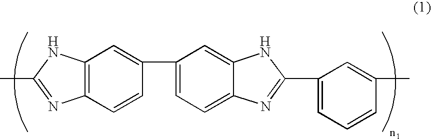

In addition, an example of the polybenzimidazole derivative includes a partially methylated polybenzimidazole having formula (2) below, in which at least a part of substituents Rs of a polybenzimidazole structure are methyl groups. In formula (2) below, R is CH₃ or H, and n₂ is about 10 to about 100,000. If n₂ is less than about 10, the mechanical strength may be reduced. If n₂ is greater than about 100,000, solubility in a solvent may be significantly reduced and it may be difficult to form the gel electrolyte into a desired shape. The partially methylated polybenzimidazole may include more phosphoric acid as the degree of methylation increases, and thus swells (gels), thereby increasing the proton conductivity.

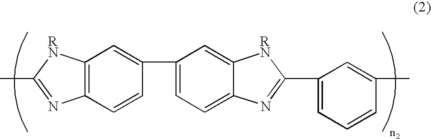

Moreover, any one of the following (1) to (3) may be used as the partially methylated polynenzimidazole.

(1) A polymethylated benzimidazole having a methylation rate adjusted to be about 5 mol % to about 80 mol % (preferably about 20 mol % to about 80 mol %).

(2) A partially methylated polynenzimidazole composed of a mixture of poly(N-methylbenzimidazole) having a methylation rate of about 100 mol % and polybenzimidazole having a methylation rate of about 0 mol %, in which the concentration of poly N-methylbenzimidazole is about 5 mol % to about 80 mol % (preferably about 20 mol % to about 80 mol %).

(3) A partially methylated polynenzimidazole composed of a mixture of polymethylated benzimidazole having a methylation rate of X mol % and polybenzimidazole having a methylation rate of 0 mol %, in which, when the weight of the polymethylated benzimidazole is represented as A, and the weight of the polybenzimidazole is represented as B, f obtained by the equation f(mol %)=AX/(A+B) is 5 mol % or greater and less than 80 mol %, and preferably 20 mol % or greater and less than 80 mol %, provided that X is 80 mol % or greater and less than 100 mol %.

According to the above (1) through (3), the methylation rate of the partially methylated polybenzimidazole may be allowed to be about 5 mol % to about 80 mol % (preferably about 20 mol % to about 80 mol %). That is, in (1), the methylation rate may be adjusted by adjusting a degree of conversion for methylation. In (2), the methylation rate may be practically adjusted by adjusting the concentration of poly(N-methylbenzimidazole). In addition, in (3), the methylation rate may be practically adjusted by adjusting the value of f.

If the methylation rate of the partially methylated polybenzimidazole is less than about 5 mol %, the proton conductivity may be insufficient due to an insufficient amount of phosphoric acid. If the methylation rate is about 80 mol % or more, the partially methylated polybenzimidazole may be dissolved due to an excessive amount of phosphoric acid.

In the specification, the compound having formula (2) above, in which a part of substituents Rs of polybenzimidazole structure are methyl groups and the remaining part are hydrogen atoms may be referred to as “polymethylated benzimidazole.” Further, the compound having formula (2) above, in which all substituents Rs of polybenzimidazole structure are methyl groups may be referred to as “poly(N-methylbenzimidazole).” In addition, the compound having formula (2), in which all substituents Rs of polybenzimidazole structure are hydrogen atoms may be referred to as “polybenzimidazole.”

The crosslinkable polymer may be a polymer having a two- or three-dimensional structure such as those used for thermosetting resins or the like. In the present invention, a fluorine-based polymer may be used as the crosslinkable polymer. The fluorine-based polymer may be suitable as an electrode for a fuel cell in terms of its thermal and chemical stability. Also, the fluorine-based polymer may not be swollen by phosphoric acid, thereby improving the mechanical strength of the gel electrolyte.

Examples of the fluorine-based polymer include perfluoropolymer that can be dissolved in an organic solvent, such as polyfluorovinylidene, polyhexafluoropropylene, a copolymer of fluorovinylidene and hexafluoropropylene, perfluorosulfonic acid-based polymer such as Nafion®, and the like. These fluorine-based polymers may be easily crosslinked by irradiation of an electron beam.

The proportion of the crosslinkable polymer to the sum of the linear polymer and the crosslinkable polymer may be in a range of about 10 to about 40% by mass, and more preferably about 15 to about 25% by mass. If the proportion of the crosslinkable polymer is less than about 10% by mass, the proportion of the linear polymer may be relatively increased and the mechanical strength of the gel electrolyte may be reduced. If the proportion of the crosslinkable polymer is greater than about 40% by mass, the proportion of the linear polymer may be relatively decreased and the proton conductivity may be lowered due to a lowered concentration of phosphoric acid.

Since the linear polymer and the crosslinkable polymer are made into a composite, even when the linear polymer is swollen by the acid, the crosslinkable polymer may not be swollen. Thus the level of the mechanical strength of the gel electrolyte may be maintained.

A method of producing the gel electrolyte according to the present invention will now be described. The method may include mixing a linear polymer and a crosslinkable polymer (which is not crosslinked), irradiating the mixture with an electron beam, and impregnating the resultant with phosphoric acid.

To mix the linear polymer with the crosslinkable polymer, a solvent that can dissolve both of the linear polymer and the crosslinkable polymer may be prepared and both polymers may be dissolved in the solvent to form a mixed solution. Then, the mixed solution may be coated on a glass plate through a doctor blade method. Next the solvent may be removed. Thereafter, the coating may be immersed in water to be swollen and then dried. Thus, a mixed resin sheet may be obtained.

Examples of the solvent used in the process include, for example, dimethylacetamide, N-methyl-2-phyrolidinone, and the like. Polybenzimidazole or a derivative thereof as described above may be used as the linear polymer. The fluorine-based polymer as described above may also be used as the crosslinkable polymer. The combination ratio of the linear polymer and the crosslinkable polymer may be such that the amount of the crosslinkable polymer with respect to the sum of the linear polymer and the crosslinkable polymer is about 10 to about 40% by mass, and more preferably about 15 to about 25% by mass.

Next, an electron beam may irradiate the mixed resin sheet. The irradiation with the electron beam may be performed by arranging an electron gun toward a surface of the mixed resin sheet and irradiating with an electron beam from the electron gun to the sheet so as to transmit the electron beam from a surface of the sheet to the other surface of the sheet. Whether the electron beam was transmitted to the sheet can be identified by arranging a dosimeter near the sheet. By transmitting the electron beam, it may be possible to sufficiently irradiate the electron beam to the inside of the sheet. Due to the irradiation of the electron beam, the crosslinkable polymer included in the sheet may be crosslinked to form a three-dimensional crosslinked structure.

If the polybenzimidazole or a derivative thereof as the linear polymer has a stiff molecular structure as represented by formula (1) and formula (2) above, it may be rarely crosslinked although the electron beam irradiates it. Thus, the polybenzimidazole, etc. may not usually be changed and the ability of swelling by phosphoric acid may remain although electron beam irradiates it.

The irradiated electron beam may have an accelerated voltage of about 1 to about 5 MeV, and more preferably about 2 to about 3 MeV. In addition, the irradiated dose may be about 20 to about 120 kGy, and more preferably about 40 to about 80 kGy. If the accelerated voltage is less than about 1 MeV, the electron beam may not be transmitted to the sheet. If the accelerated voltage is greater than 5 MeV, the irradiating apparatus may have a large size. If the irradiated dose is less than about 20 kGy, the crosslinking may not sufficiently occur. If the irradiated dose is greater than about 120 kGy, the polymers may be degraded.

The crosslinked sheet may be directly immersed in phosphoric acid to swell the linear polymer. Thus, the gel electrolyte according to the present invention may be obtained.

According to the above method, by transmitting an electron beam to the sheet including the linear polymer and the crosslinkable polymer, the crosslinking can occur inside the sheet as well as at the surface of the sheet so that the gel electrolyte having the linear polymer and the crosslinkable polymer made into a composite in the entire sheet can be obtained.

The present invention will now be described in greater detail with reference to the following examples. The following examples are for illustrative purposes and are not intended to limit the scope of the invention.

Preparation of a Mixed Resin Sheet

Polybenzimidazole was dissolved in dimethylacetamide to 10% by mass to prepare a solution. Separately, Nafion® which was sodiumized through an ion exchange and dried was similarly dissolved as a fluorine-based polymer in dimethylamide to prepare a solution with a concentration of 10% by mass. Then, the polybenzimidazole solution and the Nafion® solution were mixed with each other. In this case, the combination ratio of both solutions was adjusted such that the proportion of Nafion® to the sum of polybenzimidazole and Nafion® was 0, 10, 20, 30, 40, and 50% by mass.

Next, the mixed solutions were coated on glass plates with a doctor blade. When the coatings became opaque, drying was performed at 50° C., and then again at 150° C. Subsequently, the coatings on the glass plates were immersed in water and a swollen film was peeled away. In addition, films containing Nafion® were immersed in a beaker containing a large quantity of IN sulfuric acid while heating the beaker in a water bath maintained at 60° C. for 24 hours and an ion exchange was performed. After the ion exchange, the films were cleansed three times with distilled water and a vacuum drying was performed at 6° C. under 0.1 torr. In this manner, mixed resin sheets were prepared. A film thickness of the sheets was about 35° C.

Irradiation with the Electron Beam

The mixed resin sheets were individually sealed in an aluminum laminate film. Then, an irradiation apparatus was used to irradiate with an electron beam in a dose of 80 kGy at an accelerated voltage of 2 MeV.

Immersion in Phosphoric Acid

After the irradiation with the electron beam, the mixed resin sheet was directly immersed in 85% phosphoric acid which was preheated to 40° C. After 2 hours, the sheet was removed and the phosphoric acid on the surface of the sheet was wiped with a wiping cloth. In this manner, gel electrolytes of Examples 1-4 and Comparative Examples 1-4 were prepared. The compositions, etc., of each of gel electrolytes are shown in Table 1.

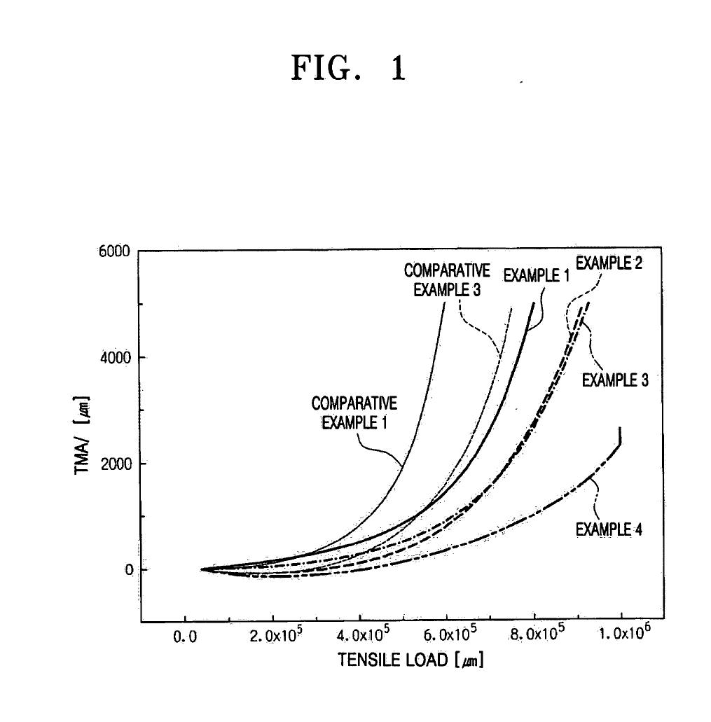

The swelling rate by phosphoric acid, the solubility in strong phosphoric acid, the tension test, and the voltage drop when being installed in a fuel cell were investigated for the gel electrolytes of Examples 1-4 and Comparative Examples 1-4. The results are shown in Table 1 and FIG. 1.

The swelling rate by phosphoric acid was obtained by the following equation from the weight of gel electrolyte after immersing it in phosphoric acid for 6 hours and the weight of the film without containing phosphoric acid.

Swelling rate (%)=((weight of gel electrolyte after being swollen by phosphoric acid)/(dry weight of film before being swollen by phosphoric acid))×100

The solubility in strong phosphoric acid was investigated by immersing the gel electrolyte in strong phosphoric acid at room temperature for 48 hours.

A tension test was performed by applying tensile loads of 40-1000 mN to the gel electrolyte at a loading rate of 100 mN/min under isothermal dry nitrogen atmosphere at 30° C. using an EXSTAR 6100 TMA/SS (available from Seiko Electronics). TMA curve was obtained from the results. A specimen of width 3.5 mm×length 20 mm was prepared. When the length increase of the specimen was 5 mm, the specimen was unloaded and extension of the specimen for a load was observed.

To investigate the voltage drop, the mixed solution diluted 10 times was thinly applied to a carbon paper to which a carbon supported Pt (available from Electrochem Inc.) was applied and the carbon paper was dried in a vacuum to form an electrode. The gel electrolyte was interposed between two electrodes to prepare a cell for a test. Then, the cell for the test was interposed between carbon separators and an open circuit voltage was measured using hydrogen as an anode gas and oxygen as a cathode gas. After checking the open circuit voltage immediately after assembly, the cell was maintained for 24 hours while supplying gas and the voltage reduced due to a crossover caused by a breakage, etc., of a film was determined. Meanwhile, the temperature of the cell was 150° C. and humidification for the supplied gas was not performed.

TABLE 1

| | | | Concentration | | Swelling | Solubility in | |
|---|---|---|---|---|---|---|---|
| | | Fluorine- | of fluorine- | Irradiation | rate by | strong | Voltage |
| | | based | based | of electron | phosphoric | phosphoric | drop |
| | Linear polymer | polymer | polymer | beam | acid | acid | (mV) |
| Example 1 | Polybenzimidazole | Nafion ® | 10% | ◯ | 400% | Partially | 0-15 |
| | | | | | | soluble | |
| Example 2 | Polybenzimidazole | Nafion ® | 20% | ◯ | 380% | Partially | 0-10 |
| | | | | | | soluble | |
| Example 3 | Polbenzimidazole | Nafion ® | 30% | ◯ | 370% | Partially | 0-10 |
| | | | | | | soluble | |
| Example 4 | Polybenzimidazole | Nafion ® | 40% | ◯ | 350% | Partially | 0-10 |
| | | | | | | soluble | |
| Comparative | Polybenzimidazole | — | 0% | X | 450% | Soluble | 20-60 |
| Example 1 | | | | | | | |
| Comparative | Polybenzimidazole | — | 0% | ◯ | 450% | Soluble | 20-70 |
| Example 2 | | | | | | | |
| Comparative | Polybenzimidazole | Nafion ® | 10% | X | 410% | Soluble | 0-30 |
| Example 3 | | | | | | | |
| Comparative | Polybenzimidazole | Nafion ® | 50% | Impossible | — | Soluble | — |
| Example 4 | | | | | | | |

Regarding the swelling rates by phosphoric acid of Examples 1-4, changes in weight reached an equilibrium after about 3 hours and equivalent swelling rates measured after 6 hours were 400, 380, 370, and 350% (Table 1), respectively. Meanwhile, regarding Comparative Examples 1-3, the swelling rates were 400% or more. When comparing Example 1 and Comparative Example 3, each containing 10% of Nafion®, both showed no significant differences in the swelling rates. Thus, it is apparent that the effects of irradiation of an electron beam on the swelling rate is insignificant. Further, the swelling rates of Examples 1-4 are lowered as the concentration of Nafion® increases.

Regarding the solubilities in strong phosphoric acid of Examples 1-4, as shown in Table 1, they are partially soluble. However, insolubility increases as the concentration of Nafion® increases. Meanwhile, in Comparative Example 3 without irradiation of an electron beam polyimidazole is completely dissolved in strong phosphoric acid.

Regarding the tensile strength shown in FIG. 1, when comparing Example 1 and Comparative Example 3, each containing 10% by mass of Nafion®, there is a small difference in the extension for a tensile load irrespective of irradiation with an electron beam.

As illustrated in Examples 1-4 of FIG. 1, the extension for tensile load decreases as the concentration of Nafion® increases.

Examples 1-4 with irradiation from an electron beam have a crosslinked structure formed by crosslinking and have improved mechanical strength compared to Comparative Example 3 without irradiation from an electron beam. This may be because they are partially dissolved in strong phosphoric acid and an extension for tensile load is decreased.

Regarding the voltage drop identified for the gel electrolytes of Examples 1-4 installed in the fuel cells, as shown in Table 1, the reduction in the open circuit voltage after 24 hours was insignificant compared to Comparative Examples 1-3. Thus, it is apparent that the gel electrolytes of Examples 1-4 have superior endurance.

Comparative Example 1 has a large swelling rate by phosphoric acid of about 450%. However, as seen from FIG. 1, since its mechanical strength is insufficient, the reduction in the open circuit voltage after 24 hours is significant compared to Examples 1-4 and its endurance is deteriorated. This can be identified from the results obtained by installing the gel electrolytes in fuel cells and testing them (Table 1).

In the case of Comparative Example 2, the gel electrolyte is completely dissolved in the strong phosphoric acid. Thus, it is apparent that polybenzimidazole itself is not crosslinked even when irradiating with an electron beam. Other properties are similar to those of Comparative Example 1.

As illustrated in FIG. 1, the gel electrolyte of Comparative Example 3 has improved tensile strength compared to Comparative Example 1 but has lower tensile strength compared to Example 1 as described above.

In the case of Comparative Example 4, since the concentration of the fluorine-based polymer is high as 50% by mass, film properties are significantly poor and unevenness in the surface is also observable with the naked eye. Thus, it may be inappropriate for use as electrolyte for a fuel cell requiring evenness.

As described above, a gel electrolyte having high proton conductivity even at no added humidity and high temperatures can be provided and can have increased mechanical strength.

While the present invention has been particularly shown and described with reference to exemplary embodiments thereof, various changes may be made to these embodiments without departing from the scope of the present invention.

1. A gel electrolyte, comprising:
an acid,
a linear polymer capable of being swollen by the acid, and
a crosslinkable polymer made into a composite with the linear polymer.

2. The gel electrolyte of claim 1, wherein the crosslinkable polymer is electron beam irradiated.

3. The gel electrolyte of claim 1, wherein the linear polymer comprises polybenzimidazole or a derivative thereof.

4. The gel electrolyte of claim 1, wherein the crosslinkable polymer comprises a fluorine-based polymer.

5. The gel electrolyte of claim 4, wherein the proportion of the fluorine-based polymer to the sum of the linear polymer and the fluorine-based polymer is about 10 to about 40% by mass.

6. An electrode for a fuel cell, comprising:
an electrode material and a gel electrolyte, wherein the gel electrolyte comprises:
an acid,
a linear polymer capable of being swollen by the acid, and
a crosslinkable polymer made into a composite with the linear polymer.

7. The electrode of claim 6, wherein the crosslinkable polymer is electron beam irradiated.

8. The electrode of claim 6, wherein the linear polymer comprises polybenzimidazole or a derivative thereof.

9. The electrode of claim 6, wherein the crosslinkable polymer comprises a fluorine-based polymer.

10. The electrode of claim 9, wherein the proportion of the fluorine-based polymer to the sum of the linear polymer and the fluorine-based polymer is about 10 to about 40% by mass.

11. A fuel cell, comprising:
a pair of electrodes and an electrolyte membrane interposed between the electrodes,
wherein a part up to the whole of the electrolyte membrane comprises a gel electrolyte,
wherein the gel electrolyte is contained in part of the electrodes, and
wherein the gel electrolyte comprises:
an acid,
a linear polymer capable of being swollen by the acid, and
a crosslinkable polymer made into a composite with the linear polymer.

12. The fuel cell of claim 11, wherein the crosslinkable polymer is electron beam irradiated.

13. The fuel cell of claim 11, wherein the linear polymer comprises polybenzimidazole or a derivative thereof.

14. The fuel cell of claim 11, wherein the crosslinkable polymer comprises a fluorine-based polymer.

15. The fuel cell of claim 14, wherein the proportion of the fluorine-based polymer to the sum of the linear polymer and the fluorine-based polymer is about 10 to about 40% by mass.

16. A method of producing a gel electrolyte, comprising:
forming a sheet from a mixture of a linear polymer and an uncrosslinked crosslinkable polymer;
crosslinking the crosslinkable polymer by irradiating with an electron beam onto the sheet such that the electron beam is transmitted from a surface of the sheet to an opposite surface of the sheet; and
impregnating the sheet with an acid.

17. The method of claim 16, wherein an accelerated voltage of the electron beam is about 1 MeV or more.

18. The method of claim 16, wherein the linear polymer comprises polybenzimidazole or a derivative thereof.

19. The method of claim 16, wherein the crosslinkable polymer comprises a fluorine-based polymer.

20. The method of claim 19, wherein the proportion of the fluorine-based polymer to the sum of the linear polymer and the fluorine-based polymer is about 10 to about 40% by mass.
